(19) United States
(12) Patent Application Publication
(10) Pub. No.: US 2025/0039738 A1
(43) Pub. Date: Jan. 30, 2025

(54) COMBINED PACKET TRANSFER TO A RADIO FREQUENCY MODULE

(71) Applicant: QUALCOMM Incorporated, San Diego, CA (US)

(72) Inventors: Sharathchandra Sreeramareddy, Escondido, CA (US); Akshay Ravi, San Diego, CA (US); Omesh Kumar Handa, San Marcos, CA (US); Suhrid Bhatt, San Diego, CA (US)

(21) Appl. No.: 18/361,336

(22) Filed: Jul. 28, 2023

(51) Int. Cl. H04W 28/06

(52) U.S. Cl. CPC H04W 28/065

(57) ABSTRACT

This disclosure provides systems, methods, and devices for combined packet transfer from a modem to a radio frequency (RF) module. In a first aspect, a method of combined packet transfer includes receiving, by a modem coupled to a radio frequency (RF) module through a first bus, a plurality of packets for transmission to the RF module for storage in a memory of the RF module, combining, by the modem, two or more of the plurality of packets to generate a first combined packet, and transmitting, by the modem, the first combined packet to the RF module via the first bus for storage in the memory. Other aspects and features are also claimed and described.

### TECHNICAL FIELD

Aspects of the present disclosure relate generally to computer information systems, and more particularly, to transfer of information between components of a computer information system. Some features may enable and provide improved packet transfer capabilities for combined packet transfer from a modem to a radio frequency (RF) module.

### INTRODUCTION

A computing device (e.g., a laptop, a mobile phone, etc.) may include one or several processors to perform various computing functions, such as telephony, wireless data access, and camera/video function, etc. A computing device may further include one or more memories for storing information. An RF module is an important computing device component. RF modules may provide for wireless communication with other computing devices, such as through transmission and receipt of wireless signals. An RF module of a computing device may include components such as an RF front end, an RF memory, an RF controller, and other components.

An RF module may communicate with other components of a computing device via one or more modems of the computing device. The one or more modems may, for example, provide information to and receive information from an RF module via one or more buses. For example, information for storage in an RF memory, such as configuration information for the RF module, information for transmission via one or more antennas of the RF module, or information received via one or more antennas of the RF module may be communicated via one or more buses between one or more modems and the RF module.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In some aspects, a modem of a computing device may combine received packets for transmission, via a bus, to an RF module of the computing device. For example, the modem of the computing device may receive multiple packets for transmission to the RF module of the computing device via the bus. Such packets may, for example, be packets of data for storage in a memory of the RF module, such as a radio digital sub-system (RDSS) memory. The bus may have a maximum bandwidth for transmission of packets between the modem and the RF module. To increase usage of the bandwidth of the bus, the modem may combine multiple packets received by the modem to generate combined packet for transmission to the RF module via the bus. In doing so, the modem may use a combined size of the packets as a basis for determining whether to combine packets for transmission. As one particular example, the modem may limit a size of combined packets according to a maximum bandwidth of the bus. Furthermore, the modem may include address information associated with each data unit of a packet included in the combined packet to notify the RF module of an address in the memory of the RF module at which each data unit should be stored.

Combination of packets, by a modem, for transmission to an RF module via a bus may enhance efficiency of data transfer between the modem and the RF module. In some cases, such combination may reduce a time for transmission of a set of packets from a modem to an RF module by up to and exceeding fifty percent. Such reductions may allow for more rapid configuration of an RF module, reducing an amount of time required to program a memory of the RF module with configuration settings and other parameters for operation of the RF module.

Some aspects may be embodied as a sequence of commands executed by a modem. Such commands may, for example, include commands to receive packets, combine packets, and transmit packets of data to an RF module. Some aspects may be embodied as a sequence of commands executed by a controller of an RF module. Such commands may, for example, include commands to receive packets and to store particular data portions of packets at particular locations of a memory of the RF module.

An apparatus in accordance with at least one embodiment includes a modem configured to communicate with an RF module via a bus. The RF module may include a controller and a memory, such as an RDSS memory. The RF module may also include other components such as an RF front end. Likewise, the RF module, such as a controller of the RF module, may be configured to communicate with the modem via the bus. The apparatus may be a computing device. For example, the apparatus may be a user equipment (UE) device such as a cellular phone, a tablet computing device, a personal computer, a server, a smart watch, an internet of things (IoT) device, or another computing device.

In one aspect of the disclosure, a method for combined packet transfer from a modem to an RF module includes receiving, by a modem coupled to a radio frequency (RF) module through a first bus, a plurality of packets for transmission to the RF module for storage in a memory of the RF module, combining, by the modem, two or more of the plurality of packets to generate a first combined packet, and transmitting, by the modem, the first combined packet to the RF module via the first bus for storage in the memory.

In an additional aspect of the disclosure, a method for combined packet transfer from a modem to an RF module includes receiving, by a controller of a radio frequency (RF) module from a modem coupled to the RF module via a first bus, a first combined packet generated, by the modem, by combination of two or more of a plurality of packets received by the modem and storing, by the controller, data of the combined packet in a memory of the RF module.

In an additional aspect of the disclosure, an apparatus includes at least one processor and a memory coupled to the at least one processor. The at least one processor is configured to perform one or more operations of the methods, operations, and/or techniques described herein. The processor may be a processor, controller, or other logic circuitry in a modem or an RF module.

In an additional aspect of the disclosure, an apparatus includes a modem coupled to a RF module through a first bus and configured to transmit data for storage in a memory of the RF module through the first bus. The modem is configured to perform one or more operations of the methods, operations, and/or techniques described herein.

In an additional aspect of the disclosure, an apparatus includes an RF module including a controller and a memory and coupled to a modem through a first bus. The controller of the RF module may be configured to perform one or more operations of the methods, operations, and/or techniques described herein.

In an additional aspect of the disclosure, an apparatus includes means for performing one or more operations of the methods, operations, and/or techniques described herein. For example, an apparatus may include a modem coupled to a RF module through a first bus and configured to transmit data for storage in a memory of the RF module through the first bus, in which the modem includes means for receiving a plurality of packets for transmission to the RF module for storage in the memory, means for combining two or more of the plurality of packets to generate a first combined packet, and means for transmitting the first combined packet to the RF module via the first bus for storage in the memory. As another example, an apparatus may include an RF module including a controller and a memory and coupled to a modem through a first bus, in which the controller includes means for receiving, from the modem, a first combined packet generated, by the modem, by combination of two or more of a plurality of packets received by the modem and means for storing data of the combined packet in the memory.

In an additional aspect of the disclosure, an apparatus, such as a wireless device, includes at least one processor and a memory coupled to the at least one processor. The at least one processor is configured to communicate with the memory system through a memory controller coupled to a channel that couples the processor to the memory system. The processor may be a processor, controller, or other logic circuitry in an RF module or in or coupled to a modem of a computing device.

In an additional aspect of the disclosure, a non-transitory computer-readable medium stores instructions that, when executed by a processor, cause the processor to perform operations described herein regarding aspects of the disclosure.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a bus interface to perform the steps of the method. In some embodiments, the bus interface may be integrated with a processor that is part of a mobile device including a first network adaptor coupled to the processor through the bus interface with the first network adaptor configured to transmit data (e.g., images or videos in a previously-recorded file or as streaming data) over a first network connection of a plurality of network connections. The processor may be coupled to the first network adaptor and a memory for storing data through a common bus interface or multiple bus interfaces to support the processing and communications operations performed by the processor. The network adaptor may support communication over a wireless communications network such as a 5G NR communication network. The processor may cause the transmission of data by retrieving the data stored in memory over a bus interface, package the data for transmission on a selected network, and transmit the packaged data through the bus interface to the first network adaptor for transmission on the wireless communication network.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.).

While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations.

In some configurations, devices incorporating described aspects and features may also include additional components and features for implementation and practice of claimed and described aspects. For example, transmission and reception of wireless signals may includes a number of components for analog and digital purposes (e.g., hardware components including antenna, radio frequency (RF)-chains, power amplifiers, modulators, buffer, processor(s), interleaver, adders/summers, etc.). Innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 illustrates one example of an apparatus that may be adapted according to certain aspects disclosed herein.

FIG. 2 is a block diagram illustrating combination of a plurality of packets to generate a combined packet and locations in a memory for storage of data units of the combined packet according to one or more aspects of the present disclosure.

FIG. 3 is a block diagram illustrating combination of a plurality of packets to generate a combined packet and locations in a memory for storage of data units of the combined packet according to one or more aspects of the present disclosure.

FIG. 4 is a flow diagram illustrating an example process that supports combined packet transfer from a modem to a radio frequency (RF) module according to one or more aspects of the present disclosure.

FIG. 5 is a flow diagram illustrating an example process that supports combined packet transfer from a modem to a radio frequency (RF) module according to one or more aspects of the present disclosure.

FIG. 6 is a flow diagram illustrating an example process that supports combined packet transfer from a modem to a radio frequency (RF) module according to one or more aspects of the present disclosure.

FIG. 7 is a block diagram illustrating details of an example wireless communication system according to one or more aspects of the present disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support data processing, including techniques for combined packet transfer from a modem to a RF module of a computing device. For example, a modem of a computing device may combine received packets for transmission, via a bus, to an RF module of the computing device. The bus may have a maximum bandwidth for transmission of packets between the modem and the RF module. To increase usage of the maximum bandwidth of the bus, the modem may combine multiple packets into combined packets for transmission to the RF module via the bus. In doing so, the modem may use a combined size of the packets as a basis for determining whether to combine packets for transmission. As one particular example, the modem may limit a size of combined packets according to a maximum bandwidth of the bus.

Particular implementations of the subject matter described in this disclosure may be implemented to realize one or more of the following potential advantages or benefits. In some aspects, the present disclosure provides for enhanced data transfer efficiency in transmission of packets, by a modem, to an RF module via a bus through combination of packets for transmission. In some cases, such combination may reduce a time of transmission of a set of packets from a modem to an RF module by up to and exceeding fifty percent. Such reductions may allow for more rapid configuration of an RF module, reducing an amount of time required to program a memory of the RF module with configuration settings and other parameters for operation of the RF module.

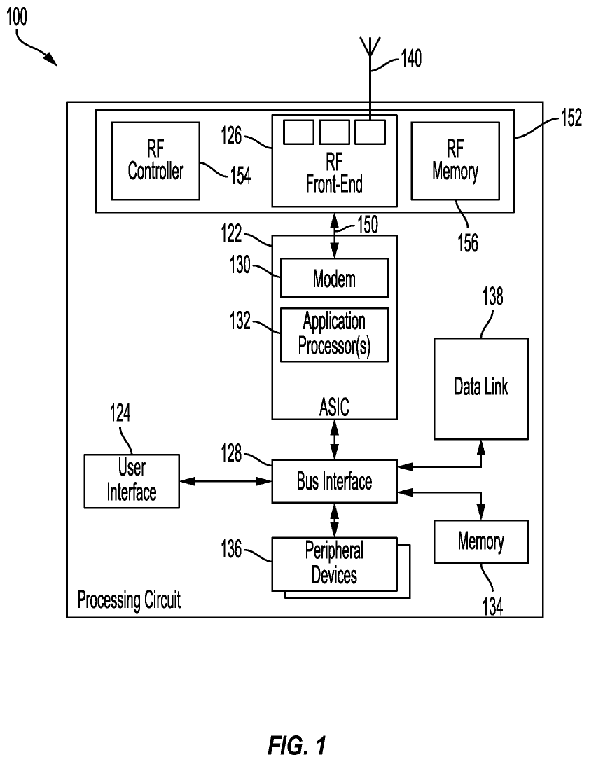

According to certain aspects a modem of a computing device may be connected to an RF module, such as an RF chip, of the computing device via a bus with a particular maximum bandwidth. The computing device may, for example, be a UE, a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, or any other similar functioning device. FIG. 1 depicts an example of such an apparatus 100. The apparatus 100 may include multiple devices or circuits 122, 124, 126, 128, 136, 138, 152, 154, and/or 156. In some aspects, the apparatus 100 may be a processing circuit that is a component of a larger apparatus. The apparatus may, for example be implemented in an application-specific IC (ASIC) or system on chip (SoC) that may include multiple devices or circuits 122, 124, 126, 128, 136. 138, 152, 154, and/or 156 as different components that may communicate with each other through busses. In one example, the apparatus 100 may be a communication device and may include a modem 130 that interfaces with a radio frequency (RF) RF module 152 that enables the apparatus to communicate through one or more antennas 140 with a radio access network, a core access network, the Internet and/or another network.

The apparatus 120 may include an application-specific integrated circuit (ASIC) device 122. The ASIC device 122 may include one or more application processors 132 (e.g., a heterogenous mix of processors of different configurations, such as performance cores and efficiency cores), one or more modems 130 (e.g., baseband modems), and/or other logic circuits or functions. In some aspects, the modem 130 may be separate from the ASIC device 122. The apparatus 120 may be controlled by a basic input/output system (BIOS), firmware, and/or an operating system and may provide an application programming interface (API) layer that enables the one or more processors 132 to execute software modules residing in the memory device 134. The software modules may include instructions and data stored in a processor readable storage such as the memory device 134.

The ASIC device 122 may access an internal memory, the memory device 134, and/or storage devices included in peripheral devices 136 or storage devices outside the apparatus 120. Memory may include read-only memory (ROM) or random-access memory (RAM), electrically erasable programmable ROM (EEPROM), flash cards, or any memory device that can be used in processing systems and computing platforms. The apparatus 120 may include, or have access to, a local database or other parameter storage that maintains operational parameters and other information used to configure and operate the apparatus 100. The local database may be implemented using registers, a database module, flash memory, magnetic media, EEPROM, optical media, tape, soft or hard disk, or the like. The apparatus 100 may also be operably coupled to external devices such as the antennas 140, a display, user interface 124 (e.g., a button, an integrated or external keypad, and/or a touch screen).

The apparatus 100 may communicate through a bus interface circuit 128, which may include a combination of circuits, counters, timers, control logic and other configurable circuits or modules. In one example, the bus interface circuit 128 may be configured to operate in accordance with PCIe specifications and protocols. The apparatus 100 may include or control a power management function that configures and manages the bus interface 128, the user interface 124, the RF front-end circuit 126, and the operation of one or more application processors 132 resident in the ASIC device 122. In certain modes of operation, the bus interface circuit 128 may be configured to transition between power states based on activity of the bus interface 128.

The modem 130 of the apparatus 100 may communicate with an RF module 152 of the apparatus 100, such as an RF chip, via a bus 150. In some aspects, the RF module may be an RF SOC. In some aspects the modem 130 may receive multiple packets for transmission to the RF module 152, such as from one or more application processors 132 or from an external source. In some aspects, such packets may be packets for storage in an RF memory 156 of the RF module 152, such as packets for configuration of operating parameters of the RF module 152, such as operating parameters of the RF front end circuit 126. The RF memory 156 may, for example, be an RDSS memory of the RF module 152.

When the modem 130 receives packets for transmission to the RF module 152 via the bus 150, the modem may transmit the packets to the RF module 152, such as to an RF controller 154 of the RF module 152. The RF controller 154 may determine to store data units of the packets in the RF memory 156 based on address information associated with the packets and/or data units.

If the modem 130 transmit packets to the RF mode sequentially as soon as possible after the packets are received by the modem 130, such transmission may result in inefficiencies in utilization of a maximum bandwidth of the bus 150, such as when the packets are not contiguous in terms of a location in the RF memory 156 at which data units of the packets will be stored. Thus transmission of packets from the modem 130 to the RF module 152 via the bus 150 as soon as they are received by the modem 150 may lead to under-utilization of the bandwidth of the bus 150. Such under-utilization may introduce latency in transmission of information between the modem 130 and the RF module 152 via the bus 150.

Latency may be reduced by combination of packets received by the modem 130 into combined packets for transmission via the bus 150 to the RF module 152. For example, multiple packets received by the modem 130 may be combined to generate a single scatter packet. To allow for inclusion of data units for storage at non-contiguous locations in the RF memory 156 in the combined packet, data units may each be stored in the combined packet with an associated destination address information unit. Thus, for example, a combined packet may include one or more data unit-address information unit pairs including data units from multiple packets received by the modem 130. The destination address information units may allow data units for storage at noncontiguous locations in the RF memory 156 to be included in the same combined packet. As one particular example a modem may receive a set of two or more packets and may determine whether to combine packets of the two or more packets into one or more combined packets. A determination of whether to combined two or more packets to generate a combined packet may be based on a bandwidth of the bus 150 connecting the modem 130 to the RF module 152. For example a maximum size for the combined packet, including data units and associated address information units, may be set based on the bandwidth of the bus 150. One example maximum size for a combined packet is 32 units.

Combined packets, and packets which the modem 130 determines not to combine, may be transmitted via the bus 150 to the RF module 152. The RF module 152 may receive the packets and may store data units of the packets at particular locations in the RF memory 156. For example, data units of a packet that is not combined may be stored at contiguous locations in the RF memory 156, while data units of a combined packet may be stored at locations in the RF memory 156 based on addresses of the RF memory 156 indicated by corresponding destination address information units of the combined packet.

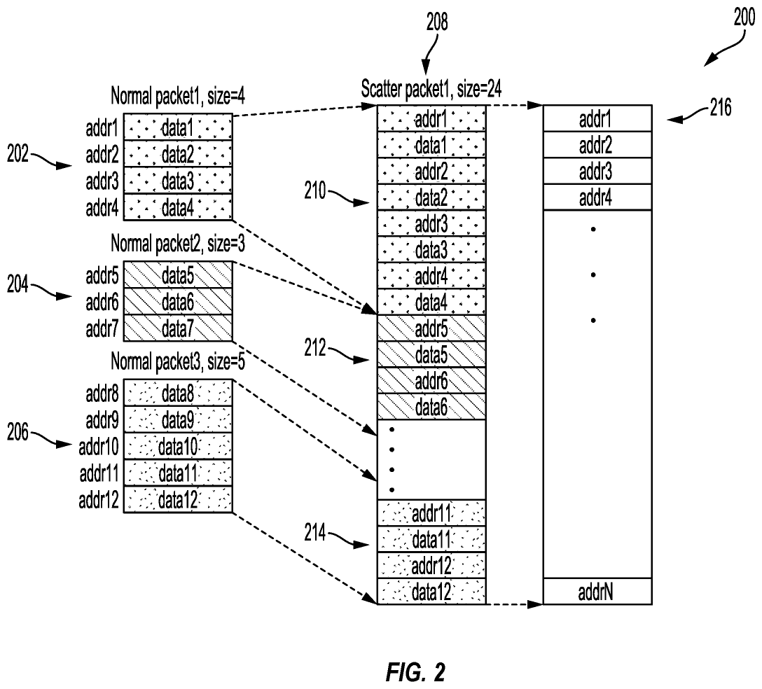

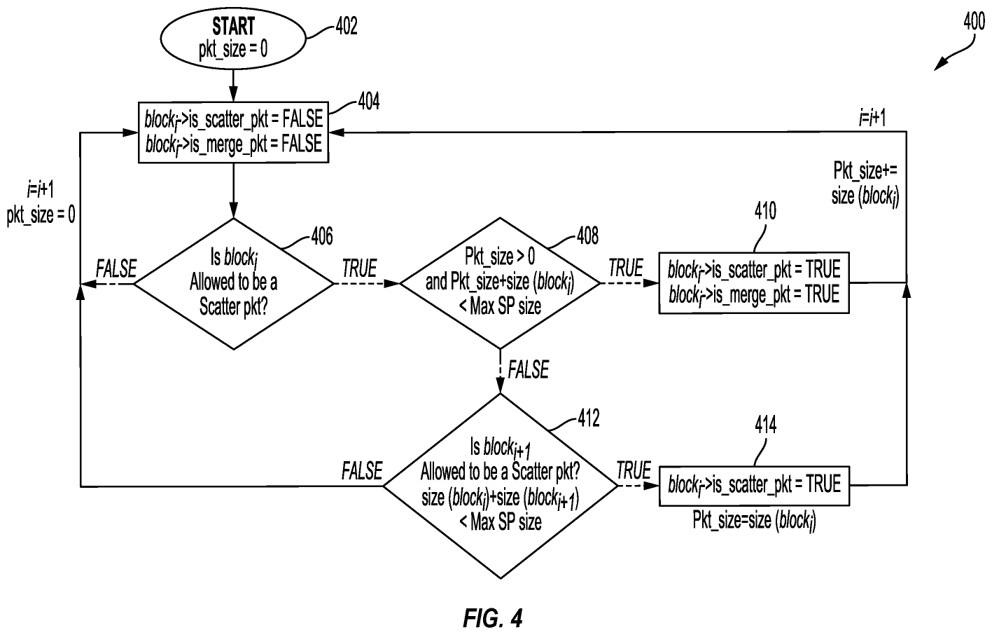

A block diagram 200 illustrating combination of a plurality of packets to generate a combined packet and locations in a memory for storage of data units of the combined packet is shown in FIG. 2. A first packet 202, a second packet 204, and a third packet 206 may be received by a modem for transmission to an RF module of a computing device. In some aspects, more or fewer than three packets may be received by the modem and may be considered for combination. The first packet 202 may include four data units for storage at four respective corresponding consecutive address of an RF memory of the RF module. The second packet 204 may include three data units for storage at corresponding respective consecutive addresses of the RF memory. In some aspects, the addresses of the RF memory at which the data units of the second packet 204 are to be stored may not be adjacent to addresses of the RF memory at which the data units of the first packet 202 are to be stored. The third packet 206 may include five data units for storage at corresponding respective consecutive addresses of the RF memory. The modem may determine that the first packet 202, the second packet 204, and the third packet 206 may be combined to form a scatter packet 208 for transmission to the RF module. The computing device may, for example, determine that a combined size of data units and corresponding address units for each data unit of the packets 202, 204, 206 is less than or equal to 32 units or payloads. For example, if a corresponding address unit is generated and included in the combined packet for each data unit, the modem may determine that a size of the combined packet is equal to two times the combined size of the data units of the packets 202, 204, 206. In some aspects, in determining to combine the first packet 202, the second packet 204, and the third packet 206, the modem may perform a sequential process for combining the first packet and the second packet, and then the combined first and second packets with the third packet, such as according to the process described with respect to FIG. 4. The modem may then generate destination address information units for each respective data unit of each of the packets 202, 204, 206 and may combine the data units and address units to generate a combined packet 208, which may also be referred to as a scatter packet. In some aspects, the respective data units of the combined packet 208 may be stored adjacent to and following their corresponding destination address information units. The combined packet 208 may include a first portion 210 including data and associated destination address information units for the first packet 202, a second portion 212 including data and associated destination address information units for the second packet 204, and a third portion 214 including data and associated destination address information units for the third packet 206. The modem may transmit the combined packet 208 to the RF module via a bus, such as to a controller of the RF module. The RF module may receive the combined packet 208 and may store each of the data units at a corresponding address of the memory 216 identified by the corresponding destination address information unit for each data unit. Thus, the twelve data units of the combined packet 208 may be stored at twelve respective addresses of the memory 216. In some aspects, the data units of the packets 202, 204, 206 may include transceiver hardware payload data, such as radio frequency integrated circuit (RFIC) settings, RF system configuration settings, or other settings associated with particular operation scenarios. In some aspects, the modem may only combine sequential packets in an order the packets are numbered and/or received by the modem to generate combined packets. For example, if the second packet 204 is unable to be combined with the first packet 202 or the third packet 206, such as due to a size of a combined packet including the second packet 204 being greater than a maximum packet size, the modem may not combine the first packet 202 and the third packet 206, even if a combined packet of the first packet 202 and the third packet 206 would be less than a maximum combined packet size, as the first packet 202 and the third packet 206 are not adjacent in timing of receipt by the modem and/or packet numbering.

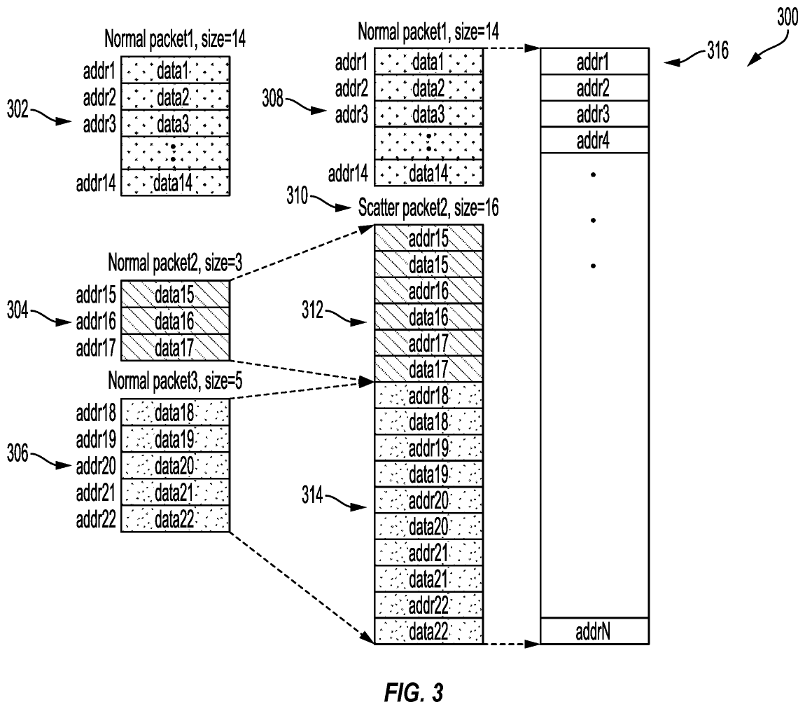

A block diagram 300 illustrating combination of a plurality of packets to generate a combined packet and locations in a memory for storage of data units of the combined packet is shown in FIG. 3. The packets 302, 304, 306 of the block diagram 300 may be similar to the packets 202, 204, 206 described with respect to FIG. 2. However, the first packet 302 may include fourteen data units for storage at fourteen consecutive memory addresses of an RF memory, while the second packet 304 may have three data units and the third packet 306 may have five data units. Thus, when determining whether to combine the first packet 302 with the second packet 304 and/or the third packet 306, the modem may determine that a combined packet including the first packet 302 would exceed the maximum packet size. For example, a combined packet size of a combined packet including data units and corresponding destination address information units for the first packet 302 and the second packet 304 would be thirty-four data and address information units, which may exceed a maximum packet size of thirty-two data units. Thus, the modem may determine to transmit the first packet 308 individually, without adding address information units for storage of data units of the first packet 308 at corresponding addresses of the memory 316. The modem may determine that the second packet 304 and the third packet 306 may be combined to generate a combined packet 310. For example, the modem may determine that a size of the combined packet 310 is sixteen data and destination address information units, which may be less than a maximum size, such as thirty-two data and destination address information units. The modem may generate the combined packet including the data units of the second packet 304 and corresponding destination address information units in a first portion 312 and the data units of the third packet 306 and corresponding destination address information units in a second portion 314 of the combined packet 310. The modem may transmit the combined packet 310 to an RF module via a bus, such as to a controller of the RF module. The RF module may receive the combined packet 310 and may store each of the data units at a corresponding address of the memory 316 identified by the corresponding destination address information unit for each data unit. Thus, if the modem determines that a packet may not be combined with another packet without the combined packet exceeding a maximum packet size, the modem may transmit the packet individually, without combination with another packet.

A modem may determine whether packets are combinable based on whether packets, when combined, would exceed a maximum packet size. FIG. 4 is a flow diagram illustrating an example process 400 that supports combined packet transfer from a modem to a radio frequency (RF) module according to one or more aspects of the present disclosure. The process 400 may, for example, be performed by a modem of a computing device as described herein. The process 400 may begin at block 402 with a first packet, with a packet number set to i, and a packet size tracking value set to zero. At block 404, a scatter packet flag for the first packet may be set to false. The scatter packet flag may be set to false when the packet is not included in a combined packet for transmission from the modem to an RF module and true when the packet is a combined packet including multiple packets. Likewise a merge packet flag may also be set to false for the first packet. The merge packet flag may be set to false when the packet cannot be merged with a previous packet and true when the packet may be merged with a previous packet. Thus, when each packet is first processed, scatter packet flags and merge packet flags for the packet may be set to false and may be updated as the packet is processed according to the process 400. At block 406, a determination may be made of whether the first packet, with the packet number set to i, may be a scatter packet. For example, at block 406, the modem may determine whether the packet may be combined with a subsequent packet. Such a determination may, for example include determination of whether a size of the packet is under a threshold packet size. Thus, block 406 may, for example, include determining whether a single packet currently being processed is too large to be combined with other packets in a combined, or scatter, packet. The determination of block 406 may also include a determination of whether the currently processed packet is a type of packet that may be included in a combined packet. For example, if a maximum packet size is thirty-two, the modem may determine whether the first packet has fewer than sixteen data units. If a determination is made, at block 406, that the packet may not be a scatter packet, the packet size tracking value may be reset to zero and the first packet may be transmitted individually. The modem may then proceed to block 404 and may begin determination of whether a second packet, with a packet number set to i+1, may be combined with a subsequent packet.

If a determination is made, at block 406, that the first packet may be a scatter packet, a determination may be made at block 408 of whether the packet size tracking value is greater than zero and the sum of the packet size tracking value and the size of the first packet is less than or equal to a maximum packet size value. For example, at block 408 the modem may determine whether the last processed packet was included in a combined packet either alone or with other prior packets, as indicated by the packet size tracking value, and whether the currently processed packet is too large to add to the combined packet, as indicated by the sum of the packet size tracking value and the size of the current packet. Because the packet size value is set to zero with the first packet, and therefore the packet size tracking value is not greater than zero, the process may proceed to block 412. At block 412, a determination may be made of whether a next packet may be combined with the current packet. For example, a determination may be made of whether a second packet, with a packet number i+1, may be combined with the first packet, with a packet number of i, without exceeding a maximum packet size. For example, the modem may determine whether a size of the combined packet including the first packet and the second packet is less than or equal to a maximum packet size. The maximum packet size may, for example, be half of a maximum transmission packet size to account for addition of destination address information units to the combined packet. Thus, the determination at block 412 may be a determination of whether a next packet can be combined with the currently processed packet in a combined packet. If a determination is made that the first packet cannot be combined with the second, subsequent packet, the packet size tracking value may be reset to zero, and the process may proceed to processing of the second packet, with a packet number set to i+1, at block 404.

If a determination is made, at block 412, that the first packet can be combined with the second packet, the process may proceed to block 414. At block 414, a scatter packet flag for the first packet may be set to true, and the packet size tracking value may be set to the size of the first packet. The process may then proceed to processing of the second packet at block 404. A scatter packet flag and a merge packet flag for the second packet may be set to false. At block 406, the modem may, for example, determine that the second packet may be a scatter packet. For example, the modem may determine that a size of the second packet is less than half of a maximum packet size. Although it is assumed, for didactic purposes, that the second packet may be a scatter packet, the second packet need not necessarily be allowed to be a scatter packet. At block 408, the modem may determine whether the packet size tracking value is greater than zero and whether the sum of the packet size tracking value and the size of second first packet is less than or equal to a maximum packet size value. The maximum packet size value may, for example, be half of a maximum combined packet size to account for addition of corresponding destination address information units to the combined packet. As the packet size tracking value is set to the size of the first packet, and the size of the first packet combined with the second packet is less than the maximum packet size, the method 400 may proceed to block 410. At block 410, the modem may set a scatter packet flag to the currently processed packet, in this example the second packet, to true to indicate that the currently processed packet may be combined with subsequent packets in a scatter packet and the merge packet flag of the currently processed packet, in this example the second packet, to true to indicate that the currently processed packet is to be combined in a combined or scatter packet with the previously processed packet, in this example the first packet. The size of the currently processed packet, in this example the second packet, may be added to the packet size tracking value, and the method may proceed to block 404 for processing of a next packet, in this example a third packet with a packet number set to i+2. Thus, when a packet is a first packet of a combined packet, a scatter packet flag of the packet may be set to true while a merge packet flag may remain at false. When a packet is a second, or later, packet of a combined packet, both a scatter packet flag and a merge packet flag of the packet may be set to true. When a packet is not to be combined with other packets, both a scatter packet flag and a merge packet flag of the packet may remain false. Furthermore, when a determination is made that a subsequent packet cannot be added to a current combined packet, the packet size tracking value may be reset for tracking of a size of a new combined packet.

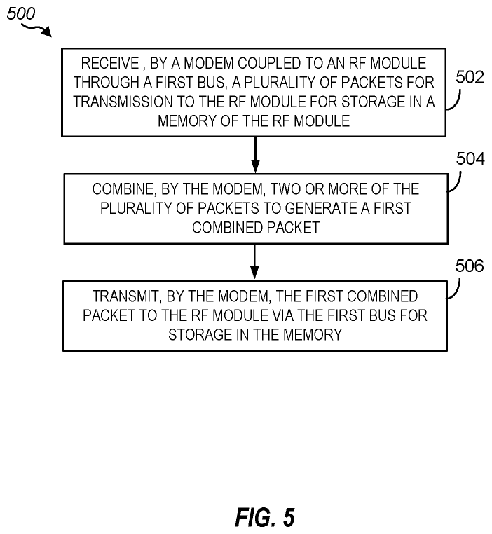

FIG. 5 is a flow diagram illustrating an example process 500 that supports combined packet transfer from a modem to a radio frequency (RF) module according to one or more aspects of the present disclosure. The process 500 may, for example, be performed by a modem of a computing device. The modem may be coupled to an RF module of the computing device via a first bus for transmission of packets for storage in a memory of the RF module. At 502, a modem coupled to an RF module through a first bus may receive a plurality of packets for transmission to the RF module for storage in a memory of the RF module. In some aspects, the packets may, for example, include configuration information for the RF module, such as RFIC configuration parameters, RF system configuration parameters, and other parameters for various operating scenarios. The packets may, for example, include information for configuration of an RF front end of the RF module. In some aspects, the modem may wait until all packets of a set multiple packets are received before beginning to process and/or combine the packets. The memory of the RF module may, for example, be an RDSS memory of the RF module. The packets may each include one or more data units for storage at particular addresses in the memory of the RF module. In some aspects, all data units in a received packet may be data units for storage at respective consecutive addresses in the memory of the RF module.

At block 504, the modem may combine two or more of the plurality of packets to generate a combined packet. In some aspects, a modem may determine sizes of packets of the plurality of packets and may determine based on the sizes whether the packets can be combined to generate a combined packet without exceeding a maximum combined packet size. In some aspects, the modem may combine only consecutive packets. In some aspects, determination of whether to combine packets may be performed as described with respect to FIG. 4. Generation of a combined packet may, for example, include generation of a respective destination address information unit for each data unit of each packet to be combined to allow an RF module to determine an address in the memory at which each data unit should be stored. Thus a determination of whether a combined packet size does not exceed a maximum combined packet size may include determining whether the combined packet size including the data units and associated destination address information units does not exceed a maximum packet size. In some aspects, the maximum packet size may be thirty-two data units. As one particular example, the modem may determine a first size of a first packet of the plurality of packets and a second size of a second packet of the plurality of packets. The second packet may, for example, be adjacent to the first packet in an order in which packets were received by the modem or in an order of numbering of the packets. The modem may determine based, at least in part, on the first size and the second size, that a third size of the first combined packet including the first packet and the second packet will be less than or equal to a threshold size. The modem may then combine the first packet with the second packet to generate the first combined packet based, at least in part, on the determination that the third size will be less than or equal to the threshold size. In processing a subsequent packet, the modem may determine a fourth size of a third packet, adjacent to the second packet. The modem may, for example, determine that adding the third packet to the first combined packet would cause the third size of the first combined packet to exceed the threshold size. Thus, the modem may refrain from adding the third packet to the first combined packet based on the determination that adding the third packet to the first combined packet would cause the third size to exceed the threshold size. Although the third packet may not be combined with the first packet and the second packet, the third packet may be combined with one or more subsequent packets. For example, the modem may determine a fifth size of a fourth packet of the plurality of packets, where the fourth packet is adjacent to the third packet. The mode may determine based, at least in part, on the fourth size and the firth size that a sixth size of a second combined packet including the third packet and the fourth packet will be less than or equal to the threshold size. The modem may then combine the third packet with the fourth packet to generate the second combined packet based, at least in part, on the determination that the sixth size will be less than or equal to the threshold size. A combined packet may include one or more packets received by the modem when the data units of the one or more packets are included in the combined packet. The threshold size may, for example, be sixteen data units, or thirty-two data and destination address information units. In some aspects, the threshold size may be associated with and/or determined based on a maximum bandwidth of the first bus.

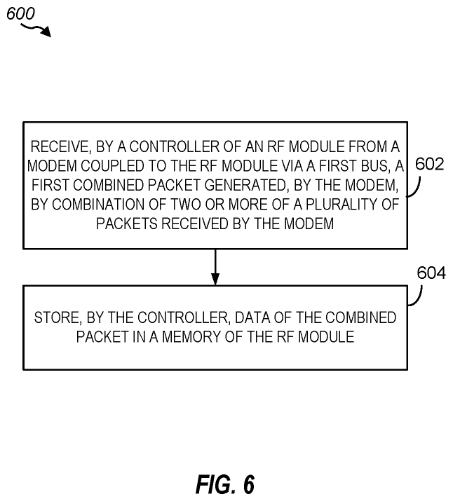

FIG. 6 is a flow diagram illustrating an example process 600 that supports combined packet transfer from a modem to a radio frequency (RF) module according to one or more aspects of the present disclosure. The process 600 may, for example, be performed by an RF module of a computing device, such as by a controller of an RF module of a computing device. The controller may be coupled to modem of the computing device via a first bus for reception of packets for storage in a memory of the RF module. At 602, the controller of the RF module may receive, from a modem coupled to the RF module via a first bus, a first combined packet. The first combined packet may, for example, be a packet generated, by the modem, by combination of two or more of a plurality of packets received by the modem. The memory of the RF module may, for example, include an RDSS memory. The plurality of packets may, for example, include configuration information for the RF module, as described herein. The first combined packet may include multiple data units of multiple packets combined to generate the first combined packet and a respective destination address information unit for each data unit. Thus, for example, the first combined packet may include a first data unit of a first packet of the two or more of the plurality of packets, a first destination address information unit associated with the first data unit, a second data unit of a second packet of the two or more of the plurality of packets, and a second destination address information unit associated with the second data unit. In some aspects, the first packet may include fewer than or equal to sixteen data units and sixteen associated destination address information units.

At block 604, the controller of the RF module may store data of the combined packet in a memory of the RF module. For example, the controller of the RF module may store data units of the RF module at addresses in the RF memory indicated by the respective destination address indication units associated with the respective data units. Thus, for example, the controller may store a first data unit at a first location of the memory based on the first destination address information unit and a second data unit at a second location of the memory based on the second destination address information unit. In some aspects, the addresses at which the data units of the different packets are stored may not be contiguous.

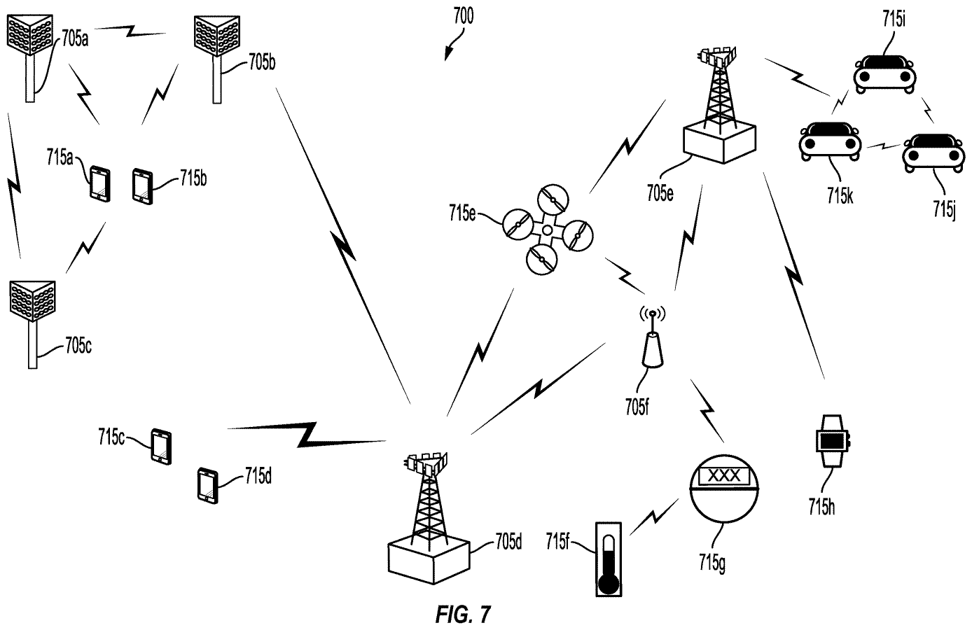

Operations of method 500 or 600 may be performed by a user equipment (UE), a base station (BS), other communications device, or other computer information system, such as any of the devices described with reference to FIG. 7. For example, example operations (also referred to as “blocks”) of method 500 or 600 may enable UE 615 to support greater data transfer rates at lower power consumption while communicating over high-speed communications networks. FIG. 7 is a block diagram illustrating details of an example wireless communication system according to one or more aspects. The wireless communication system may include wireless network 700. Wireless network 700 may, for example, include a 5G wireless network. As appreciated by those skilled in the art, components appearing in FIG. 7 are likely to have related counterparts in other network arrangements including, for example, cellular-style network arrangements and non-cellular-style-network arrangements (e.g., device to device or peer to peer or ad hoc network arrangements, etc.).

Wireless network 700 illustrated in FIG. 7 includes a number of base stations 705 and other network entities. A base station may be a station that communicates with the UEs and may also be referred to as an evolved node B (eNB), a next generation eNB (gNB), an access point, and the like. Each base station 705 may provide communication coverage for a particular geographic area. In 3GPP, the term “cell” may refer to this particular geographic coverage area of a base station or a base station subsystem serving the coverage area, depending on the context in which the term is used. In implementations of wireless network 700 herein, base stations 705 may be associated with a same operator or different operators (e.g., wireless network 700 may include a plurality of operator wireless networks). Additionally, in implementations of wireless network 700 herein, base station 705 may provide wireless communications using one or more of the same frequencies (e.g., one or more frequency bands in licensed spectrum, unlicensed spectrum, or a combination thereof) as a neighboring cell. In some examples, an individual base station 705 or UE 715 may be operated by more than one network operating entity. In some other examples, each base station 705 and UE 715 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 7, base stations 705d and 705e are regular macro base stations, while base stations 705a-705c are macro base stations enabled with one of 3 dimension (3D), full dimension (FD), or massive MIMO. Base stations 705a-705c take advantage of their higher dimension MIMO capabilities to exploit 3D beamforming in both elevation and azimuth beamforming to increase coverage and capacity. Base station 705f is a small cell base station which may be a home node or portable access point. A base station may support one or multiple (e.g., two, three, four, and the like) cells.

Wireless network 700 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 715 are dispersed throughout the wireless network 700, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 715, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 715a-715d of the implementation illustrated in FIG. A are examples of mobile smart phone-type devices accessing wireless network 700. A UE may also be a machine specifically configured for connected communication, including machine type communication (MTC), enhanced MTC (eMTC), narrowband IoT (NB-IoT) and the like. UEs 715e-715k illustrated in FIG. 7 are examples of various machines configured for communication that access wireless network 700.

A mobile apparatus, such as UEs 715, may be able to communicate with any type of the base stations, whether macro base stations, pico base stations, femto base stations, relays, and the like. In FIG. A, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 700 may occur using wired or wireless communication links.

In operation at wireless network 700, base stations 705a-705c serve UEs 715a and 715b using 3D beamforming and coordinated spatial techniques, such as coordinated multipoint (CoMP) or multi-connectivity. Macro base station 705d performs backhaul communications with base stations 705a-705c, as well as small cell, base station 705f. Macro base station 705d also transmits multicast services which are subscribed to and received by UEs 715c and 715d. Such multicast services may include mobile television or stream video, or may include other services for providing community information, such as weather emergencies or alerts, such as Amber alerts or gray alerts.

Wireless network 700 of implementations supports mission critical communications with ultra-reliable and redundant links for mission critical devices, such UE 715e, which is a flying device. Redundant communication links with UE 715e include from macro base stations 705d and 705e, as well as small cell base station 705f. Other machine type devices, such as UE 715f (thermometer), UE 715g (smart meter), and UE 715h (wearable device) may communicate through wireless network 700 either directly with base stations, such as small cell base station 705f, and macro base station 705e, or in multi-hop configurations by communicating with another user device which relays its information to the network, such as UE 715f communicating temperature measurement information to the smart meter, UE 715g, which is then reported to the network through small cell base station 705f. Wireless network 700 may also provide additional network efficiency through dynamic, low-latency TDD communications or low-latency FDD communications, such as in a vehicle-to-vehicle (V2V) mesh network between UEs 715i-715k communicating with macro base station 705c.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably. A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards. A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long-term evolution (LTE) is a release of UMTS that uses E-UTRA. The various different network types may use different radio access technologies (RATs) and RANS.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

In one or more aspects, techniques for supporting data storage and/or data transmission, may include additional aspects, such as any single aspect or any combination of aspects described below or in connection with one or more other processes or devices described elsewhere herein. In a first aspect, an electronic device, such as a UE, may be an apparatus that includes a modem coupled to a radio frequency (RF) module through a first bus and configured to transmit data for storage in a memory of the RF module through the first bus. The modem, in the first aspect, may be configured to perform operations including receiving a plurality of packets for transmission to the RF module for storage in the memory, combining two or more of the plurality of packets to generate a first combined packet, and transmitting the first combined packet to the RF module via the first bus for storage in the memory. Additionally, the apparatus may perform or operate according to one or more aspects as described below. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, the memory comprises a radio digital sub-system (RDSS) memory of the RF module.

In a third aspect, in combination with one or more of the first aspect or the second aspect, the plurality of packets comprise configuration information for configuring the RF module.

In a fourth aspect, in combination with one or more of the first aspect through the third aspect, to combine two or more of the plurality of packets to generate a first combined packet, the modem is further configured to perform operations including determining a first size of a first packet of the plurality of packets, determining a second size of a second packet of the plurality of packets, wherein the second packet of the plurality of packets is adjacent to the first packet of the plurality of packets, determining based, at least in part, on the first size and the second size, that a third size of the first combined packet including the first packet and the second packet will be less than or equal to a threshold size, and combining the first packet with the second packet to generate the first combined packet based, at least in part, on the determination that the third size will be less than or equal to a threshold size.

In a fifth aspect, in combination with one or more of the first aspect through the fourth aspect, the modem is further configured to perform operations including determining a fourth size of a third packet of the plurality of packets, wherein the third packet is adjacent to the second packet, determining that adding the third packet to the first combined packet would cause the third size of the first combined packet to exceed the threshold size, and determining to refrain from adding the third packet to the first combined packet based on the determination that adding the third packet to the first combined packet would cause the third size to exceed the threshold size.

In a sixth aspect, in combination with one or more of the first aspect through the fifth aspect, the modem is further configured to perform operations including determining a fifth size of a fourth packet of the plurality of packets, wherein the fourth packet is adjacent to the third packet, determining based, at least in part, on the fourth size and the fifth size, that a sixth size of a second combined packet including the third packet and the fourth packet will be less than or equal to the threshold size, and combining the third packet with the fourth packet to generate the second combined packet based, at least in part, on the determination that the sixth size will be less than or equal to the threshold size.

In a seventh aspect, in combination with one or more of the first aspect through the sixth aspect, the threshold size is sixteen data units.

In an eighth aspect, in combination with one or more of the first aspect through the seventh aspect, the threshold size is associated with a maximum bandwidth of the first bus.

In a ninth aspect, in combination with one or more of the first aspect through the eighth aspect, a method includes each of the two or more of the plurality of packets comprises one or more data units, and wherein to combine two or more of the plurality of packets to generate a first combined packet and the modem is further configured to perform operations comprising including a respective destination address information unit associated with each of the respective one or more data units of each of the two or more of the plurality of packets in the first combined packet.

In one or more aspects, techniques for supporting data storage and/or data transmission, may include additional aspects, such as any single aspect or any combination of aspects described below or in connection with one or more other processes or devices described elsewhere herein. In a tenth aspect, an electronic device, such as a UE, may be an apparatus that includes a radio frequency (RF) module comprising a controller and a memory and coupled to a modem through a first bus, the controller configured to perform operations comprising. The controller, in the first aspect, may be configured to perform operations including receiving, from the modem, a first combined packet generated, by the modem, by combination of two or more of a plurality of packets received by the modem and storing data of the combined packet in the memory. Additionally, the apparatus may perform or operate according to one or more aspects as described below. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In an eleventh aspect, in combination with the tenth aspect, the memory comprises a radio digital sub-system (RDSS) memory of the RF module.

In a twelfth aspect, in combination with one or more of the tenth aspect through the eleventh aspect, the plurality of packets comprise configuration information for configuring the RF module.

In a thirteenth aspect, in combination with one or more of the tenth aspect through the twelfth aspect, the first combined packet comprises a first data unit of a first packet of the two or more of the plurality of packets, a first destination address information unit associated with the first data unit, a second data unit of a second packet of the two or more of the plurality of packets, and a second destination address information unit associated with the second data unit.

In a fourteenth aspect, in combination with one or more of the tenth aspect through the thirteenth aspect, the combined packet includes fewer than or equal to sixteen data units and sixteen destination address information units.

In a fifteenth aspect, in combination with one or more of the tenth aspect through the fourteenth aspect, to store the data of the combined packet in the memory, the controller is further configured to perform operations including storing the first data unit at a first location of the memory based on the first destination address information unit and storing the second data unit at a second location of the memory based on the second destination address information unit.

In the description of embodiments herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-2 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIG. 1, 4, 5, 6, or 7 may be combined with one or more blocks (or operations) described with reference to another of the figures. For example, one or more blocks (or operations) of FIGS. 3A-3B may be combined with one or more blocks (or operations) of FIG. 1 or 2. As another example, one or more blocks associated with FIG. 4, 5, or 6 may be combined with one or more blocks (or operations) associated with FIG. 1 or 7.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward” are sometimes used for ease of describing the figures, and indicate relative positions corresponding to the orientation of the figure on a properly oriented page, and may not reflect the proper orientation of any device as implemented.

As used herein, the term “coupled to” in the various tenses of the verb “couple” may mean that element A is directly connected to element B or that other elements may be connected between elements A and B (i.e., that element A is indirectly connected with element B), to operate certain intended functions. In the case of electrical components, the term “coupled to” may also be used herein to mean that a wire, trace, or other electrically conductive material is used to electrically connect elements A and B (and any components electrically connected therebetween). In some examples, the term “coupled to” mean a transfer of electrical energy between elements A and B, to operate certain intended functions.

In some examples, the term “electrically connected” mean having an electric current or configurable to having an electric current flowing between the elements A and B. For example, the elements A and B may be connected via resistors, transistors, or an inductor, in addition to a wire, trace, or other electrically conductive material and components. Furthermore, for radio frequency functions, the elements A and B may be “electrically connected” via a capacitor.

The terms “first,” “second,” “third,” etc. are employed for ease of reference and may not carry substantive meanings. Likewise, names for components/modules may be adopted for ease of reference and might not limit the components/modules. \

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. An apparatus, comprising:
a modem coupled to a radio frequency (RF) module through a first bus and configured to transmit data for storage in a memory of the RF module through the first bus, the modem configured to perform operations comprising:
receiving a plurality of packets for transmission to the RF module for storage in the memory;
combining two or more of the plurality of packets to generate a first combined packet; and
transmitting the first combined packet to the RF module via the first bus for storage in the memory.

2. The apparatus of claim 1, wherein the memory comprises a radio digital sub-system (RDSS) memory of the RF module.

3. The apparatus of claim 1, wherein the plurality of packets comprise configuration information for configuring the RF module.

4. The apparatus of claim 1, wherein to combine two or more of the plurality of packets to generate a first combined packet, the modem is further configured to perform operations comprising:
determining a first size of a first packet of the plurality of packets;
determining a second size of a second packet of the plurality of packets, wherein the second packet of the plurality of packets is adjacent to the first packet of the plurality of packets;
determining based, at least in part, on the first size and the second size, that a third size of the first combined packet including the first packet and the second packet will be less than or equal to a threshold size; and
combining the first packet with the second packet to generate the first combined packet based, at least in part, on the determination that the third size will be less than or equal to a threshold size.

5. The apparatus of claim 4, wherein the modem is further configured to perform operations comprising:
determining a fourth size of a third packet of the plurality of packets, wherein the third packet is adjacent to the second packet;
determining that adding the third packet to the first combined packet would cause the third size of the first combined packet to exceed the threshold size; and
determining to refrain from adding the third packet to the first combined packet based on the determination that adding the third packet to the first combined packet would cause the third size to exceed the threshold size.

6. The apparatus of claim 5, wherein the modem is further configured to perform operations comprising:
determining a fifth size of a fourth packet of the plurality of packets, wherein the fourth packet is adjacent to the third packet;
determining based, at least in part, on the fourth size and the fifth size, that a sixth size of a second combined packet including the third packet and the fourth packet will be less than or equal to the threshold size; and
combining the third packet with the fourth packet to generate the second combined packet based, at least in part, on the determination that the sixth size will be less than or equal to the threshold size.

7. The apparatus of claim 5, wherein the threshold size is sixteen data units.

8. The apparatus of claim 5, wherein the threshold size is associated with a maximum bandwidth of the first bus.

9. The apparatus of claim 1, wherein each of the two or more of the plurality of packets comprises one or more data units, and wherein to combine two or more of the plurality of packets to generate a first combined packet, the modem is further configured to perform operations comprising:
including a respective destination address information unit associated with each of the respective one or more data units of each of the two or more of the plurality of packets in the first combined packet.

10. A method, comprising:
receiving, by a modem coupled to a radio frequency (RF) module through a first bus, a plurality of packets for transmission to the RF module for storage in a memory of the RF module;
combining, by the modem, two or more of the plurality of packets to generate a first combined packet; and
transmitting, by the modem, the first combined packet to the RF module via the first bus for storage in the memory.

11. The method of claim 10, wherein the memory comprises a radio digital sub-system (RDSS) memory of the RF module.

12. The method of claim 10, wherein the plurality of packets comprise configuration information for configuring the RF module.

13. The method of claim 10, wherein combining, by the modem, two or more of the plurality of packets to generate a first combined packet comprises:
determining a first size of a first packet of the plurality of packets;
determining a second size of a second packet of the plurality of packets, wherein the second packet of the plurality of packets is adjacent to the first packet of the plurality of packets;
determining based, at least in part, on the first size and the second size, that a third size of the first combined packet including the first packet and the second packet will be less than or equal to a threshold size; and
combining the first packet with the second packet to generate the first combined packet based, at least in part, on the determination that the third size will be less than or equal to a threshold size.

14. The method of claim 13, further comprising:
determining, by the modem, a fourth size of a third packet of the plurality of packets, wherein the third packet is adjacent to the second packet;
determining, by the modem, that adding the third packet to the first combined packet would cause the third size of the first combined packet to exceed the threshold size; and
determining, by the modem, to refrain from adding the third packet to the first combined packet based on the determination that adding the third packet to the first combined packet would cause the third size to exceed the threshold size.

15. The method of claim 14, further comprising:
determining, by the modem, a fifth size of a fourth packet of the plurality of packets, wherein the fourth packet is adjacent to the third packet;
determining, by the modem, based, at least in part, on the fourth size and the fifth size, that a sixth size of a second combined packet including the third packet and the fourth packet will be less than or equal to the threshold size; and
combining, by the modem, the third packet with the fourth packet to generate the second combined packet based, at least in part, on the determination that the sixth size will be less than or equal to the threshold size.

16. The method of claim 13, wherein the threshold size is sixteen data units.

17. The method of claim 13, wherein the threshold size is associated with a maximum bandwidth of the first bus.

18. The method of claim 10, wherein each of the two or more of the plurality of packets comprises one or more data units, and wherein combining, by the modem, two or more of the plurality of packets to generate a first combined packet comprises:
including a respective destination address information unit associated with each of the respective one or more data units of each of the two or more of the plurality of packets in the first combined packet.

19. An apparatus, comprising:
a radio frequency (RF) module comprising a controller and a memory and coupled to a modem through a first bus, the controller configured to perform operations comprising:
receiving, from the modem, a first combined packet generated, by the modem, by combination of two or more of a plurality of packets received by the modem; and
storing data of the combined packet in the memory.

20. The apparatus of claim 19, wherein the memory comprises a radio digital sub-system (RDSS) memory of the RF module.

21. The apparatus of claim 19, wherein the plurality of packets comprise configuration information for configuring the RF module.

22. The apparatus of claim 19, wherein the first combined packet comprises a first data unit of a first packet of the two or more of the plurality of packets, a first destination address information unit associated with the first data unit, a second data unit of a second packet of the two or more of the plurality of packets, and a second destination address information unit associated with the second data unit.

23. The apparatus of claim 22, wherein the combined packet includes fewer than or equal to sixteen data units and sixteen destination address information units.

24. The apparatus of claim 22, wherein to store the data of the combined packet in the memory, the controller is further configured to perform operations comprising:
storing the first data unit at a first location of the memory based on the first destination address information unit; and
storing the second data unit at a second location of the memory based on the second destination address information unit.

25. A method, comprising:
receiving, by a controller of a radio frequency (RF) module from a modem coupled to the RF module via a first bus, a first combined packet generated, by the modem, by combination of two or more of a plurality of packets received by the modem; and
storing, by the controller, data of the combined packet in a memory of the RF module.

26. The method of claim 25, wherein the memory comprises a radio digital sub-system (RDSS) memory of the RF module.

27. The method of claim 25, wherein the plurality of packets comprise configuration information for configuring an RF front end of the RF module.

28. The method of claim 25, wherein the first combined packet comprises a first data unit of a first packet of the two or more of the plurality of packets, a first destination address information unit associated with the first data unit, a second data unit of a second packet of the two or more of the plurality of packets, and a second destination address information unit associated with the second data unit.

29. The method of claim 28, wherein the combined packet includes fewer than or equal to sixteen data units and sixteen destination address information units.

30. The method of claim 28, wherein storing the data of the combined packet in the memory comprises:
storing the first data unit at a first location of the memory based on the first destination address information unit; and
storing the second data unit at a second location of the memory based on the second destination address information unit.
